(19) United States
(12) Patent Application Publication
(10) Pub. No.: US 2016/0084391 A1
(43) Pub. Date: Mar. 24, 2016

(54) CHECK VALVE MECHANISM AND PUMP DEVICE USING THE SAME

(71) Applicant: TOSHIBA TEC KABUSHIKI KAISHA, Tokyo (JP)

(72) Inventor: Yasushi Kuribayashi, Shizuoka (JP)

(21) Appl. No.: 14/816,281

(22) Filed: Aug. 3, 2015

(30) Foreign Application Priority Data
Sep. 22, 2014 (JP) 2014-192996

(51) Int. Cl. F16K 15/02; F04B 45/047

(52) U.S. Cl. CPC F16K 15/021; F04B 45/047

(57) ABSTRACT

A check valve mechanism comprises a sealing case, a sheet component, a sheet-shaped valve body and a load adding mechanism. The sealing case has a suction opening for fluid and a discharge opening for fluid and an internal flow path connecting the suction opening with the discharge opening. The sheet component is fixed on the sealing case by covering the periphery of the suction opening and made from a resin material having an opening at a position corresponding to the suction opening. The sheet-shaped valve body is made from a resin material having a blocking area for the sheet component. The load adding mechanism adds a load for the blocking area of the sheet-shaped valve body towards the sheet component.

### CROSS-REFERENCE TO RELATED APPLICATION

This application is based upon and claims the benefit of priority from Japanese Patent Application No. 2014-192996, filed Sep. 22, 2014, the entire contents of which are incorporated herein by reference.

### FIELD

Embodiments described herein relate to a check valve mechanism and a pump device using the same.

### BACKGROUND

Some of existing small diaphragm pumps use, for example, a vibrator consisting of a piezoelectric element (hereinafter referred to as a ‘piezoelectric vibrator’). In a small diaphragm pump using a piezoelectric vibrator, the external circumferential part of the piezoelectric vibrator is hermetically supported on the internal circumferential surface of the housing of the small diaphragm pump. The piezoelectric vibrator is vibrated when applied with an alternating voltage. In this way, the internal capacity of the housing is periodically changed by curving the piezoelectric vibrator. In this case, the conveyed fluid is sucked into a pump chamber from a suction opening by a suction-side check valve, and the fluid in the pump chamber is discharged from a discharge opening through a discharge-side check valve.

Generally, in a small diaphragm pump using a piezoelectric vibrator, only a small amount of conveyed fluid is discharged at a time. Thus, a check valve needs to be actuated by a tiny pressure difference. Moreover, it is required that the check valve is opened under a set desirable differential pressure for forward flow and that reverse flow is prohibited.

In existing small diaphragm pumps, as an example, the suction-side check valve or the discharge-side check valve is an umbrella-type valve made from a flexible elastic rubber material such as silicone rubber, butyl rubber or fluoro rubber.

Further, as another example, a small diaphragm pump also uses a seat valve which is substantially formed into an L shape by a fixed base end and a movable tongue piece extending from the base end. The seat valve is integrally made from, for example, a rubber material having elasticity or a synthetic resin material.

### BRIEF DESCRIPTION OF DRAWINGS

FIG. 1 is a decomposed oblique view illustrating structural components of a check valve mechanism according to a first embodiment;

FIG. 2 is a top view illustrating a state in which a sheet component is assembled on a first sealing case of a check valve mechanism according to the first embodiment;

FIG. 3 is a sectional view taken along the line shown in FIG. 2;

FIG. 4 is an enlarged vertical sectional view of the part A shown in FIG. 3;

FIG. 5 is an oblique view illustrating the back side of a second sealing case of a check valve mechanism according to the first embodiment;

FIG. 6 is a top view illustrating a check valve mechanism according to the first embodiment;

FIG. 7 is a sectional view taken along the line VII-VII shown in FIG. 6;

FIG. 8 is an enlarged vertical sectional view of the part B shown in FIG. 7;

FIG. 9 is a vertical sectional view illustrating the main components of an opened check valve mechanism according to the first embodiment;

FIG. 10 is a vertical sectional view of the part C shown in FIG. 9;

FIG. 11 is a vertical sectional view illustrating the main components of an opened check valve mechanism through which a fluid flows according to the first embodiment;

FIG. 12 is a vertical sectional view illustrating the main components of a check valve mechanism the spring component of which is curved to collide with the inlet of a discharge opening according to the first embodiment;

FIG. 13 is an oblique view of the main components presented after a first sealing case is partially cut off from the X-shaped groove on the back side of a second sealing case of a check valve mechanism according to the first embodiment;

FIG. 14 is a top view of a pump device using a check valve mechanism according to the first embodiment;

FIG. 15 is a sectional view taken along the line XIV-XIV shown in FIG. 14;

FIG. 16 illustrates a second embodiment, in which (A) is a top view of a check valve mechanism and (B) is an oblique view of the cross-shaped rib of the shaft of a pressing component;

FIG. 17 is a sectional view taken along the line XVII-XVII shown in FIG. 16;

FIG. 18 is an oblique view of the main components presented after a second sealing case of a check valve mechanism is partially cut off according to the second embodiment;

FIG. 19 is a top view illustrating a check valve mechanism according to a third embodiment; and

FIG. 20 is a sectional view taken along the line IIX-IIX shown in FIG. 19.

### DETAILED DESCRIPTION

In accordance with an embodiment, a check valve mechanism comprises a sealing case, a sheet component, a sheet-shaped valve body and a load adding mechanism. The sealing case has a suction opening for liquid and a discharge opening for liquid and an internal flow path connecting the suction opening with the discharge opening. The sheet component which is located at the downstream side of the suction opening and fixed on the sealing case by covering the periphery of the suction opening is made from a resin material having an opening at a position corresponding to the suction opening. The sheet-shaped valve body is arranged at the downstream side of the sheet component and made from a resin material having a blocking area for blocking the opening of the sheet component. The load adding mechanism is arranged at the downstream side of the sheet-shaped valve body to add a load for the blocking area of the sheet-shaped valve body towards the sheet component.

### First Embodiment

### Structure

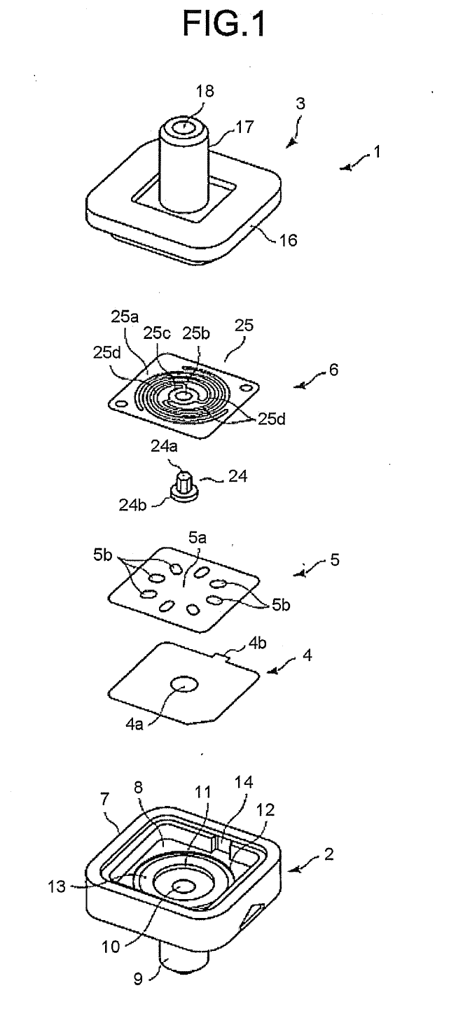

FIG. 1 to FIG. 13 illustrates the first embodiment. FIG. 1 is a decomposed oblique view illustrating structural components of a check valve mechanism 1 according to the first embodiment. In accordance with the embodiment, the check valve mechanism 1 mainly comprises a first sealing case 2, a second sealing case 3, a sheet component 4, a sheet-shaped valve body 5 and a load adding mechanism 6.

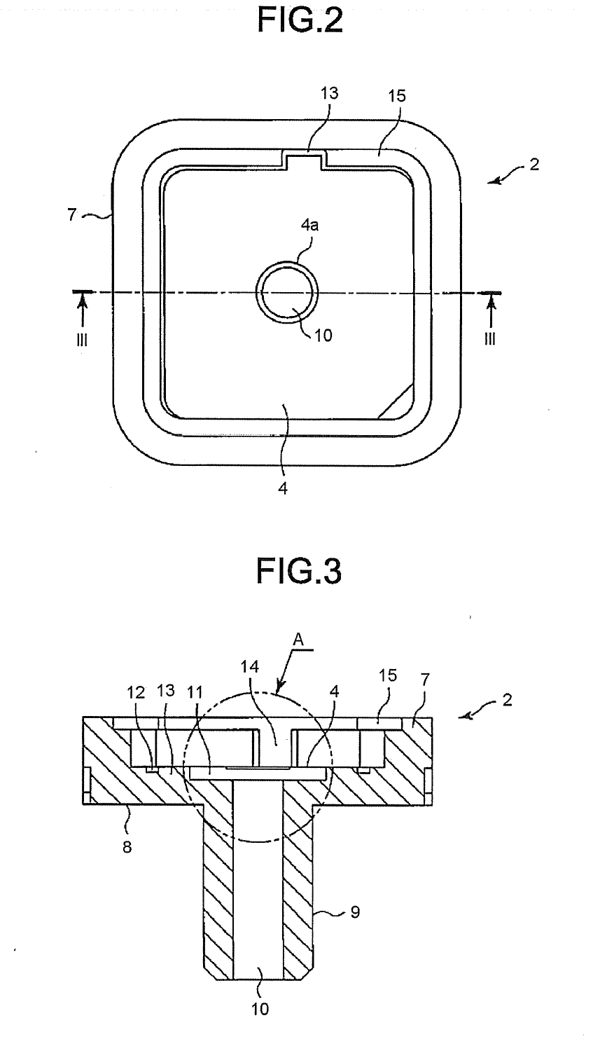

As shown in FIG. 2, the first sealing case 2 includes a main case body 7 which substantially takes the shape of a rectangular frame. As shown in FIG. 3, one end side of the main case body 7 is opened, and the other end side of the main case body 7 is provided with a base plate 8. A cylindrical suction opening body 9 is protruded in the center of the base plate 8. A suction opening 10 for fluid is formed in the axial center of the suction opening body 9.

A suction opening 10, a concentric circular recess 11 and an annular groove 12 outside of the circular recess 11 are arranged on the base plate 8 of the main case body 7. An adhesion area 13 for the adhesion of the sheet component 4 is formed between the circular recess 11 and the annular groove 12. A notch section 14 for positioning the sheet component 4 is formed on a part of the circumferential wall of the main case body 7. A stepped shape fitting recess 15 is formed on the internal side of the opened surface of the main case body 7.

The second sealing case 3 comprises a main case body 16 substantially in a rectangular plate shape and a cylindrical discharge opening body 17 protruded in the center of the main case body 16. As shown in FIG. 7, the main case body 16 is formed to be corresponding in shape and identical in size to the main case body 7 of the first sealing case 2. A discharge opening 18 for fluid is formed in the axial center of the discharge opening body 17. As shown in FIG. 5, a rectangular insertion protrusion 19 which is inserted into the rectangular frame of the main case body 7 of the first sealing case 2 is formed on the side opposite to the discharge opening body 17 of the main case body 16. A fitting protrusion 20 corresponding in shape to the fitting recess 15 of the main case body 7 of the first sealing case 2 is formed on the base of the insertion protrusion 19.

Then, as shown in FIG. 7, the insertion protrusion 19 of the main case body 16 of the second sealing case 3 is inserted into the rectangular frame of the main case body 7 of the first sealing case 2. In this case, the fitting protrusion 20 of the second sealing case 3 is fit in the fitting recess 15 of the first sealing case 2. In this way, the first sealing case 2 and the second sealing case 3 are finally hermetically fixed through adhesion. When the first sealing case 2 is assembled with the second sealing case 3, an internal flow path 21 is formed between the suction opening 10 of the first sealing case 2 and the discharge opening 18 of the second sealing case 3 to connect the suction opening 10 with the discharge opening 18.

Further, in the second sealing case 3, a circular recess 22 is formed on the front end surface of the insertion protrusion 19. An X-shaped groove 23 substantially in an X shape is formed around the inlet 18a of the discharge opening 18 on the internal bottom side of the circular recess 22.

The sheet component 4 is a rectangular plate sheet which substantially has the same size with the rectangular frame of the main case body 7 of the first sealing case 2. The sheet component 4 which is made from a resin material such as polyimide has a thickness of 25 um and a vertical elastic coefficient (Young's modulus) of 2-4 GPa, and preferably, 3 GPa. The sheet component 4 has a circular opening 4a which is formed at a position corresponding to the suction opening 10. Moreover, an engagement protrusion 4b corresponding to the notch section 14 of the main case body 7 of the first sealing case 2 is formed on the periphery of the sheet component 4.

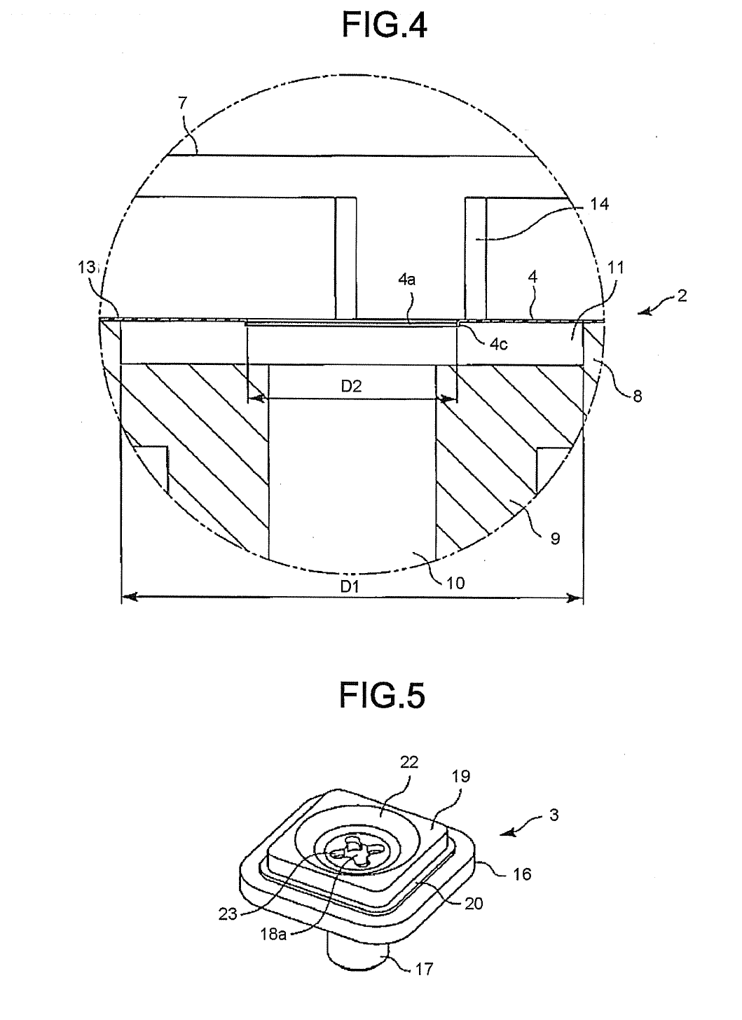

Then, the sheet component 4 is positioned at the downstream side of the suction opening 10 of the first sealing case 2 and fixed on the first sealing case 2 by covering the periphery of the suction opening 10. In the embodiment, an adhesive is coated on the adhesion area 13 of the first sealing case 2 to adhesively fix the sheet component 4 on the adhesion area 13. Thus, as shown in FIG. 4, the part of the sheet component 4 at the inner side of the adhesion area 13, that is, the part of the sheet component 4 extending into the circular recess 11 of the base plate 8 of the main case body 7, is deformable (flexible). The diameter D2 of the opening 4a of the sheet component 4 is smaller than the diameter D1 of the circular recess 11 of the base plate 8 of the main case body 7. Here, the sheet component 4 is fixed on the adhesion area 13 of the first sealing case 2 through the adhesive so as to discharge all the fluid coming from the outlet of the suction opening 10 from the opening 4a of the sheet component 4.

Further, as the adhesive also contains a material solidified through heat burning, the sheet component 4, if burnt at a high temperature and then cooled to the normal temperature, may deform because of the difference of coefficients of linear expansion. Particularly, in the case where the first sealing case 2 is greater in coefficient of linear expansion than the sheet component 4 having an opening 4a, the sheet component 4 having the opening 4a, if burnt at a high temperature and then cooled to the normal temperature, is bent and therefore hardly usable. Thus, it is preferred that the coefficient of linear expansion of the sheet component 4 having the opening 4a is equal to or greater than that of the first sealing case 2. In the case where the coefficient of linear expansion of the first sealing case 2 is smaller than that of the sheet component 4 having the opening 4a, the first sealing case 2, if burnt at a high temperature and then cooled to the normal temperature, applies a force for stretching the sheet component 4 having the opening 4a. Further, not limited to be fixed on the first sealing case 2 through adhesive fixation, for example, the sheet component 4 may also be fixed on the first sealing case 2 using a fixation method not allowing the inflow/outflow of a fluid, for example, a thermal welding method.

Further, the opening 4a and the external shape of the sheet component 4 may be formed using a punching die, a thomson die or a pinnacle die. In the case of the use of a punching die, burr 4c (refer to FIG. 4) is formed on one side of the sheet component 4 on which the opening 4a is formed. Thus, the connection of the sheet-shaped valve body 5 located at the downstream side of the sheet component 4 with the burr 4c may lead to the degradation in performance. Thus, it is set that the side of the sheet component 4 on which the burr 4c is formed is located at the upstream side, and the side on which no burrs 4c are formed is located at the downstream side. As shown in FIG. 2, the engagement protrusion 4b arranged on the sheet component 4 is arranged at a position separated from the central shaft of the sheet component 4, thus preventing the reverse installation of the sheet component 4 to guarantee the location of the side formed with the burr 4c at the upstream side and the side formed with no burrs 4c at the downstream side.

The sheet-shaped valve body 5 which is located at the downstream side of the sheet component 4 is made from a resin material having a blocking area 5a for blocking the opening 4a of the sheet component 4. Openings for the flow of a fluid, that is, eight holes 5b in the embodiment, are formed around the blocking area 5a of the sheet-shaped valve body 5. The sheet-shaped valve body 5 is made from the same material with the sheet component 4, in other words, formed to have the same Young's modulus and the same thickness with the sheet component 4. In the embodiment, the sheet-shaped valve body 5 is made from a resin material such as polyimide and has a thickness of 25 um a vertical elastic coefficient (Young's modulus) of 2-4 GPa, and preferably, 3 GPa.

The load adding mechanism 6 is located at the downstream side of the sheet-shaped valve body 5 to add, for the blocking area 5a of the sheet-shaped valve body 5, a load towards the sheet component 4. In the embodiment, the load adding mechanism 6 mainly comprises a pressing component 24 and a spring component 25. The pressing component 24 has an arc-shaped pressing section 24b on the front end of a shaft 24a, wherein the arc-shaped pressing section 24b is integrally made from a resin material such as PPS. The spring component 25 is composed of a sheet-shaped vortex spring made from nickel plated stainless steel. A hole 25b through which the shaft 24a of the pressing component 24 is inserted is formed in the center of the rectangular base plate 25a of the spring component 25. The internal ends of a plurality of gyrate arms 25d, three gyrate arms 25d in the embodiment, are connected with the periphery of an engagement ring around the hole 25b.

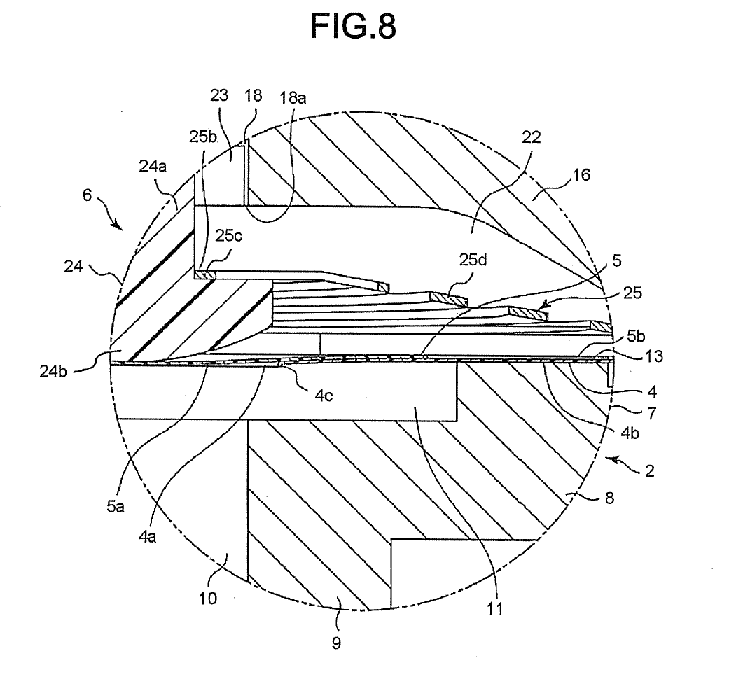

To assemble the load adding mechanism 6, the shaft 24a of the pressing component 24 is inserted through the hole 25b of the engagement ring 25c of the spring component 25 with the pressing section 24b of the pressing component 24 opposite to the blocking area 5a of the sheet-shaped valve body 5. Under this state, the first sealing case 2 and the second sealing case 3 are assembled by adding a load for the blocking area 5a of the sheet-shaped valve body 5 towards the sheet component 4 using the load adding mechanism 6. That is, when the first sealing case 2 and the second sealing case 3 are assembled, the periphery of the base plate 25a of the spring component 25 is pressed to the side of the first sealing case 2 through the periphery of the circular recess 22 on the front end of the insertion protrusion 19 of the second sealing case 3. In this case, as the pressing section 24b of the pressing component 24 collides with the blocking area 5a of the sheet-shaped valve body 5, the engagement ring 25c is motionless. Thus, the pressing force of the insertion protrusion 19 of the second sealing case 3 applied to the spring component 25 acts on the periphery of the base plate 25a of the spring component 25, the three gyrate arms 25d are elastically deformed in a stretched manner under the pressing force. Then, if the first sealing case 2 and the second sealing case 3 are assembled to correct assembly positions, then, as shown in FIG. 7, the periphery of the base plate 25a of the spring component 25 is moved to be close to the sheet-shaped valve body 5. At this time, as shown in FIG. 8, the pressing force corresponding to the elastic deformation of the three gyrate arms 25d of the sprig component 25 acts on the pressing component 24 across the engagement ring 25c of the spring component 25. The pressing force becomes a spring force by means of which the load adding mechanism 6 adds a load for the blocking area 5a of the sheet-shaped valve body 5 towards the side of the sheet component 4.

(Effect)

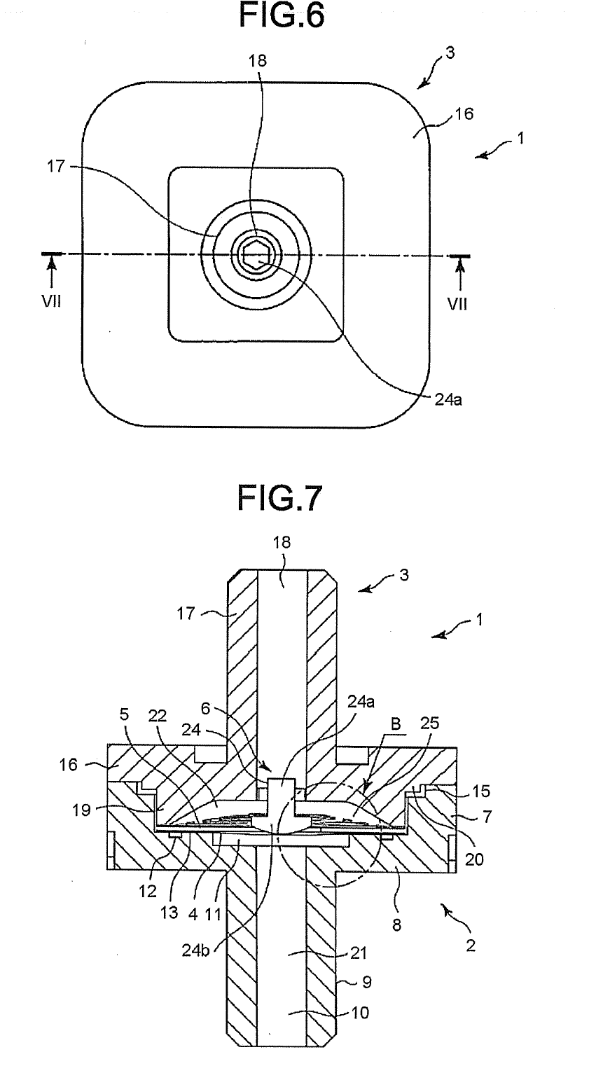

The effect of the foregoing structure is described below. FIG. 6 and FIG. 7 show a state in which the check valve mechanism 1 is assembled, and FIG. 7 and FIG. 8 show a state in which the check valve mechanism 1 is closed to give play to a unidirectional function. In this state, the load generated by the spring component 25 of the load adding mechanism 6 presses the blocking area 5a of the sheet-shaped valve body 5 through the pressing component 24. In this way, the blocking area 5a of the sheet-shaped valve body 5 is welded with the sheet component 4 through pressure welding with the opening 4a of the sheet component 4 being blocked by the blocking area 5a. The load is also transferred to the sheet component 4, and the internal side part of the sheet component 4 which is not fixedly adhered to the adhesion area 13, that is, the part of the sheet component 4 extending into the circular recess 11 of the base plate 8 of the main case body 7 (the part covering the suction opening 10), is curved under the load. Here, the sheet component 4 is made from the same material with the sheet-shaped valve body 5, that is, formed to have the same Young's modulus and the same thickness with the sheet-shaped valve body 5, thus, the sheet-shaped valve body 5 is also curved to the same extent as the sheet component 4. In this way, as shown in FIG. 8, the opening 4a of the sheet component 4 is not linearly contacted with the sheet-shaped valve body 5 but in a surface contact with the sheet-shaped valve body 5, thus achieving a high unidirectional performance.

Further, when the sheet component 4 having the opening 4a is made from a thicker member or a harder material, the sheet component 4 having the opening is linearly contacted with the sheet-shaped valve body 5. Thus, for example, if the edge of the sheet component 4 is damaged, then leakage occurs from the damaged part, making it impossible to give play to a unidirectional performance. In the embodiment, the sheet-shaped valve body 5 and the sheet component 4 are curved to the same extent in the part extending to the inside of the circular recess 11, thus, the sheet component 4 can be in surface contact with the sheet-shaped valve body 5 to prevent the foregoing situation.

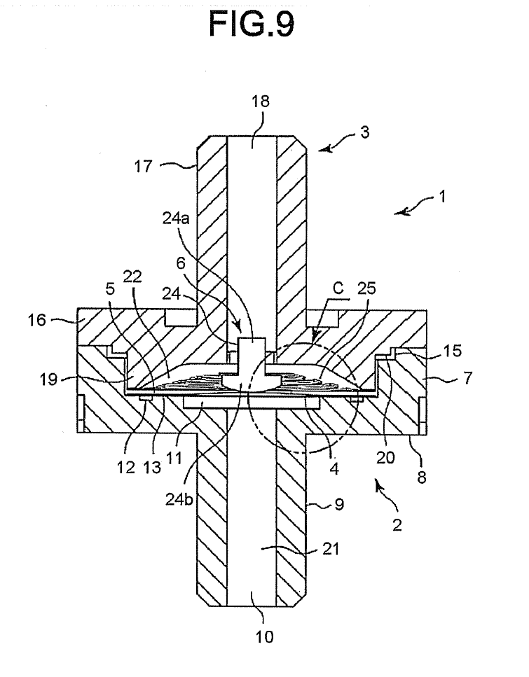

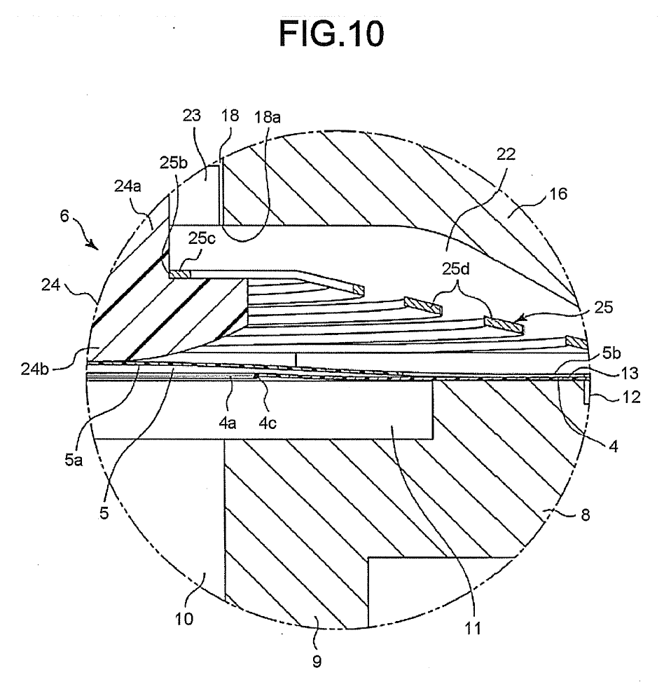

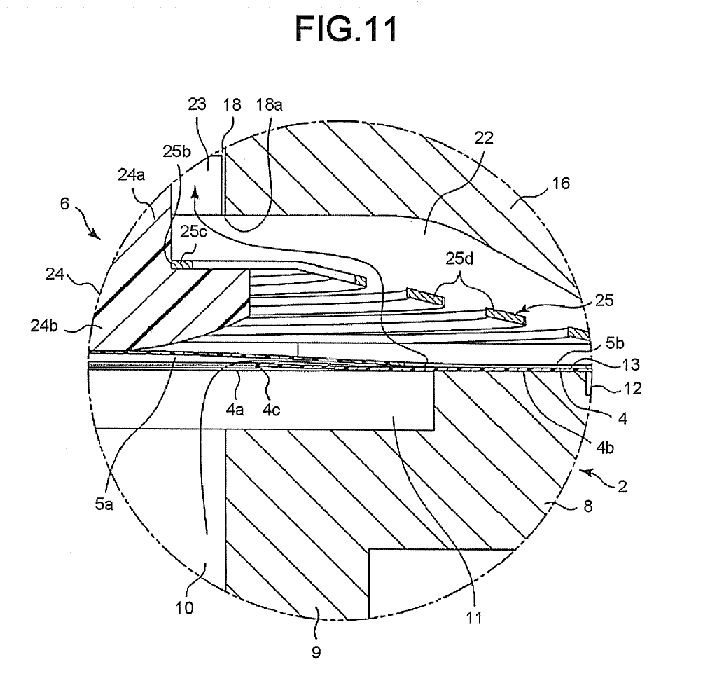

FIG. 9, FIG. 10 and FIG. 11 show a state in which the check valve mechanism 1 plays the role of an opened valve. When the check valve mechanism 1 plays the role of an opened valve, the force applied to the suction opening 10 (differential pressure*the area of the suction opening 10) is larger than the load generated by the load adding mechanism 6. When the valve of the check valve mechanism 1 is opened, the fluid flowing in the suction opening 10 of the suction opening body 9 of the first sealing case 2 flows into the opening 4a of the sheet component 4 from the suction opening 10 of the suction opening body 9 of the first sealing case 2 through the circular recess 11. Then, the part between the sheet component 4 and the sheet-shaped valve body 5 is opened under the pressure of the ingoing fluid. Thus, the fluid flows through the part between the sheet component 4 and the sheet-shaped valve body 5 and flows into the circular recess 22 of the second sealing case 3 from the hole 5b of the sheet-shaped valve body 5. Then, the fluid flows into the discharge opening 18 of the second sealing case 3 through the gaps among the three gyrate arms 25d of the spring component 25 and flows out from the outlet of the discharge opening 18 of the second sealing case 3.

In the check valve mechanism 1 of the first embodiment, the part of the sheet component 4 having the opening 4a which is not adhesively fixed, that is, the part of the sheet component 4 extending into the circular recess 11 (the part covering the suction opening 10), can transfer a pressure. Thus, the area of the diameter D1 of the circular recess 11 shown in FIG. 4 can transfer a pressure. Here, if the sheet component 4 having the opening 4a is made from a thicker member or a harder material, the part extending into the circular recess 11 is wholly incapable of transferring a pressure. In this case, the area of the diameter D2 of the opening 4a of the sheet component 4 shown in FIG. 4 becomes a pressure transferring part. Thus, the structure of the embodiment can play the role of an opened valve under a smaller differential pressure than in a case where the sheet component 4 having the opening 4a is made from a thicker member or a harder material on the condition that the load of the load adding mechanism 6 is the same. In other words, in a pressure setting for the same purpose of opening a valve, in the structure of the embodiment, as the load of the load adding mechanism 6 can be set to be larger, the sealing property and the stability of the opening 4a of the sheet component 4 and the sheet-shaped valve body 5 can be improved.

(Effect)

Thus, the check valve mechanism 1 with the foregoing structure has the following effect: function as a check valve mechanism 1 which has a high unidirectional performance even if the check valve mechanism 1 uses no component having a small longitudinal elastic coefficient (Young's modulus) (made from rubber). As the opening of the check valve mechanism 1 is determined by balancing the pressure applied to the part of the sheet component 4 having the opening 4a which is not adhesively fixed, that is, the area of the sheet component 4 extending to the internal diameter D1 of the circular recess 11 and the load adding mechanism 6, the check valve mechanism 1 can function under a tiny differential pressure. Further, the load of the load adding mechanism 6 can be increased, thus, the sealing property and the stability of the opening 4a of the sheet component 4 and the sheet-shaped valve body 5 can be improved.

Thus, a high unidirectional performance can be achieved even in the use of a component made from a material having a small longitudinal elastic coefficient, for example, rubber, the check valve mechanism 1 can function under a tiny differential pressure. Further, with a desirable chemical resistance, the sealing property of the opening 4a of the sheet component 4 and the sheet-shaped valve body 5 is improved, and the stability of the check valve mechanism 1 is also improved.

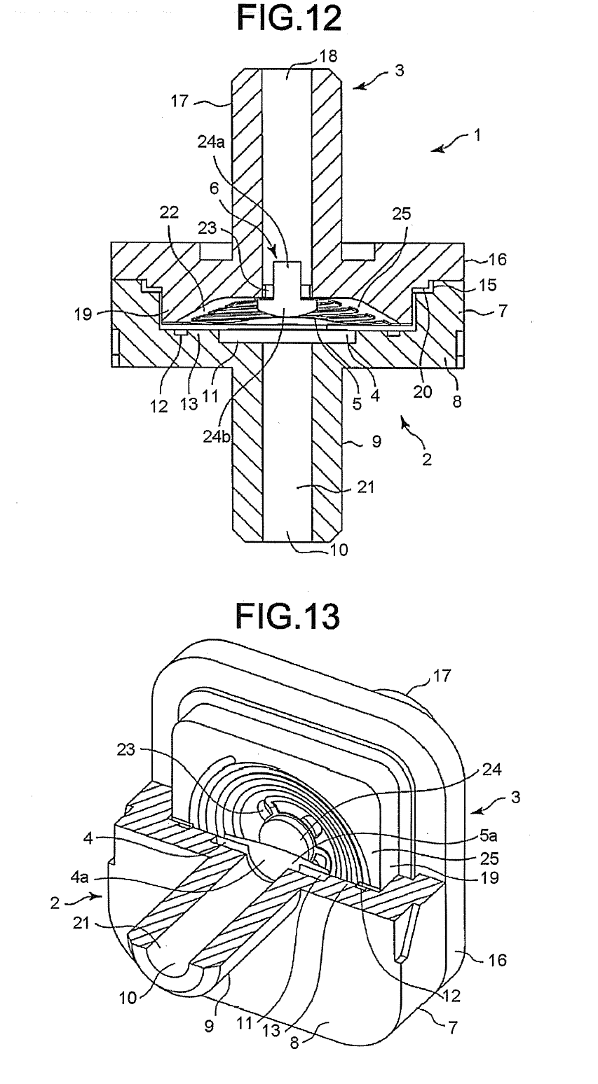

Further, if the flux from the suction opening 10 of the first sealing case 2 is large, it is considered to curve the spring component 25 of the load adding mechanism 6 considerably, as shown in FIG. 12, to collide with the inlet 18a of the discharge opening 18 so that the spring component 25 blocks the inlet 18a of the discharge opening 18. In the embodiment, as shown in FIG. 11, the inlet 18a of the discharge opening 18 of the second sealing case 3 is dug into an X-shaped groove 23. Thus, as shown in FIG. 12, even if the spring component 25 collides with and blocks the inlet 18a of the discharge opening 18, however, as shown in FIG. 13, fluid can flow to the discharge opening 18 through the X-shaped groove 23.

[A Pump Device Using the Check Valve Mechanism 1 of the First Embodiment]

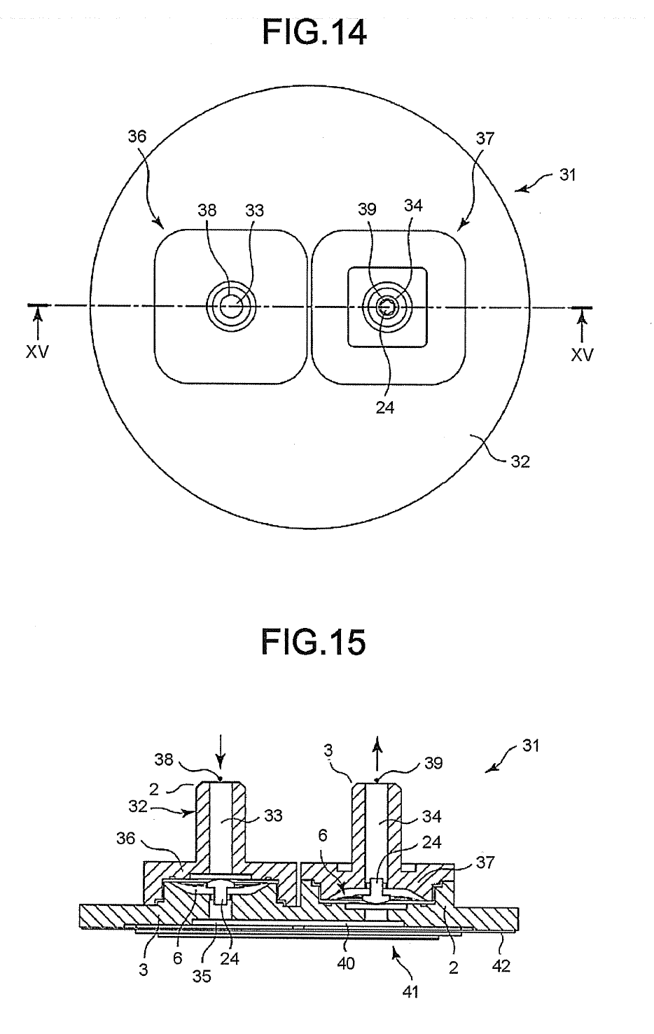

FIG. 14 is a top view of a pump device 31 using the check valve mechanism 1 according to the first embodiment (refer to FIG. 1 to FIG. 13), and FIG. 15 is a sectional view taken along the line XIV-XIV shown in FIG. 14. The pump device 31 comprises: a housing 32, a suction flow path 33, a discharging flow path 34, a pump chamber 35, a suction-side check valve 36 and a discharge-side check valve 37. The conveyed fluid flows into the housing 32 through the suction flow path 33. The discharging flow path 34 discharges the conveyed fluid out from the housing 32. The pump chamber 35 is configured as a partitioning chamber consisting of the suction opening 38 and the discharge opening 39 which are communicated with the inside of the housing 32.

The pump chamber 35 has a recess part 40 which is formed on an end surface of the housing 32. The opening of the recess part 40 is blocked by a piezoelectric diaphragm 41. The piezoelectric diaphragm 41 comprises a resin diaphragm 42 and a piezoelectric vibrating plate 43 adhered on the diaphragm 42. The piezoelectric vibrating plate 43 is vibrated repeatedly by a drive source (not shown), the adhered diaphragm 42 is vibrated repeatedly as well, thus, the piezoelectric diaphragm 41 is wholly vibrated repeatedly.

Further, the suction-side check valve 36 is arranged at the side of the suction opening 38 of the pump chamber 35, and the discharge-side check valve 37 is arranged at the side of the discharge opening 39 of the pump chamber 35. The suction-side check valve 36 and the discharge-side check valve 37 are structurally identical to the check valve mechanism 1 of the first embodiment. Here, the suction-side check valve 36 is provided with a first sealing case 2 on the side of the suction flow path 33 and a second sealing case 3 on the side of the pump chamber 35. Then, the conveyed fluid flowing from the suction flow path 33 passes the suction-side check valve 36 and then flows to the side of the pump chamber 35. Contrarily, the flow of the conveyed fluid from the pump chamber 35, through the suction-side check valve 36, to the suction flow path 33 is prevented. In this way, the reverse flow of the conveyed fluid coming from the suction-side check valve 36 is prevented.

Further, the discharge-side check valve 37 is provided with a first sealing case 2 at the side of the pump chamber 35 and a second sealing case 3 at the side of the discharging flow path 34. Then, the conveyed fluid flows from the pump chamber 35, through the discharge-side check valve 37, to the discharging flow path 34. Contrarily, the flow of the conveyed fluid from the discharging flow path 34, through the discharge-side check valve 37, to the side of the pump chamber 35 is prevented. In this way, the reverse flow of the conveyed fluid discharged from the discharge-side check valve 37 is prevented.

Then, when the pump device is driven, the piezoelectric diaphragm 41 is vibrated repeatedly to suck the conveyed fluid in and eject the conveyed fluid out. At this time, as indicated by the solid arrow shown in FIG. 15, the conveyed fluid flows into the suction flow path 33 from the suction opening 38 and is then sucked into the pump chamber 35 by the suction-side check valve 36. Further, as indicated by the solid arrow shown in FIG. 15, the fluid in the pump chamber 35 flows through the discharging flow path 34 and is ejected from the discharge opening 39 by the discharge-side check valve 37. Then, the reverse flow of the conveyed fluid is prevented by the suction-side check valve 36 and the discharge-side check valve 37.

In the pump device 31 of the embodiment, the check valve mechanism 1 of embodiment functions as the suction-side check valve 36 and the discharge-side check valve 37. Thus, like the check valve mechanism 1 of embodiment, the pump device can achieve a high unidirectional performance even in the use of a component made from a material having a small longitudinal elastic coefficient, for example rubber, and can function under a tiny differential pressure. Further, with a desirable chemical resistance, the sealing property of the opening 4a of the sheet component 4 and the sheet-shaped valve body 5 is improved, and the stability of the pump device 31 is also improved.

### Second Embodiment

### Structure

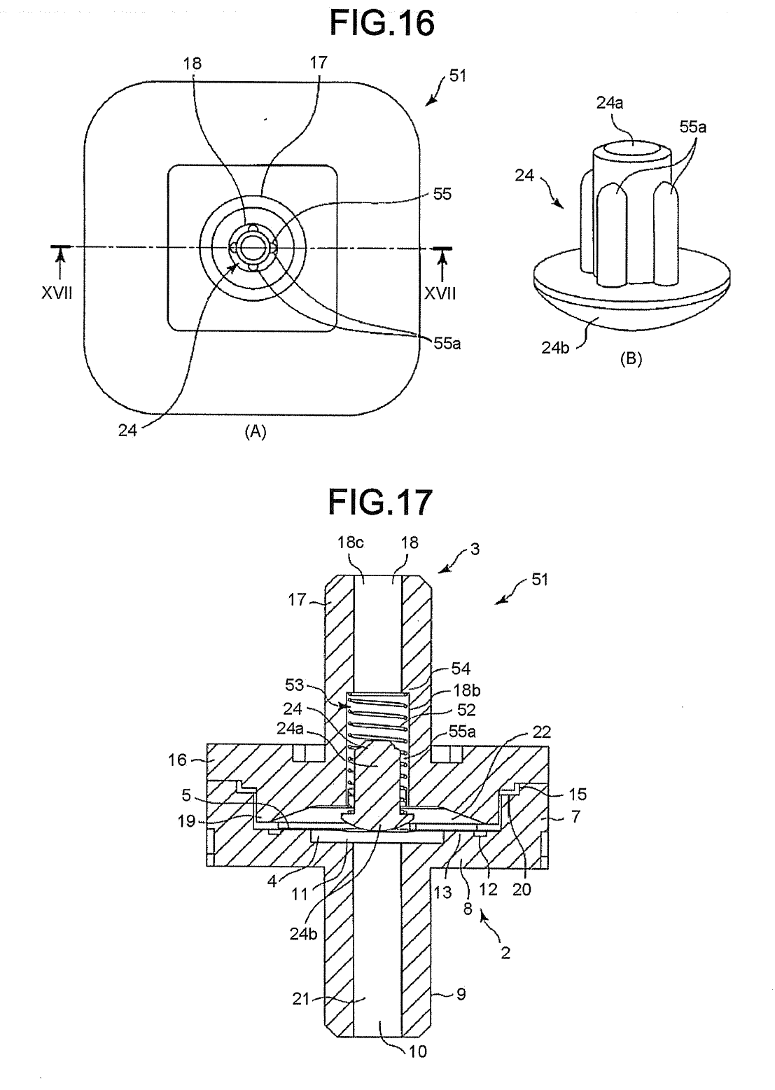

FIG. 16 to FIG. 18 illustrates the second embodiment. The second embodiment is a variation of the first embodiment in which the load adding mechanism 6 of the check valve mechanism 1 of the first embodiment (refer to FIG. 1-FIG. 13) is structurally changed as follows. Moreover, the same parts shown in FIG. 16-FIG. 18 and FIG. 1-FIG. 13 are denoted by the same reference signs and not described repeatedly.

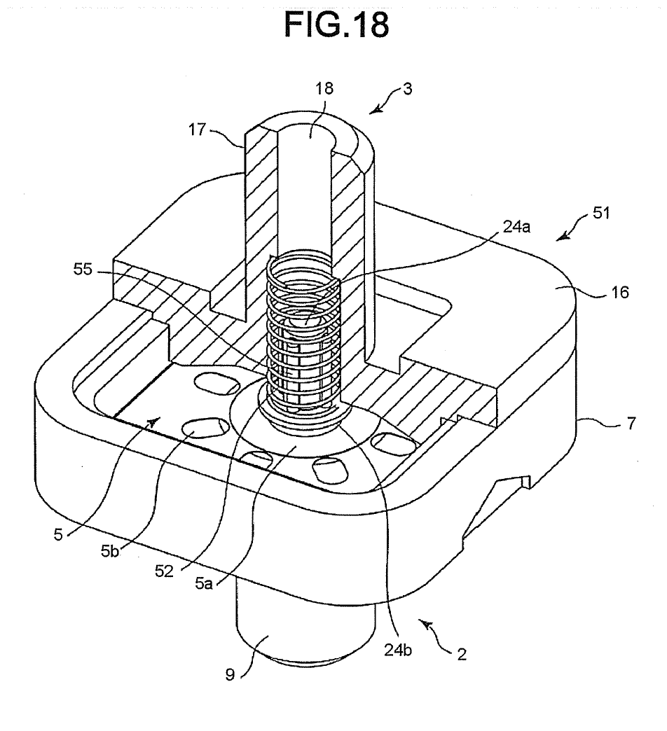

FIG. 16 (A) is a top view of a check valve mechanism 51 according to the second embodiment, FIG. 16 (B) is an oblique view of the under-mentioned cross-shaped rib 155 of the shaft 24a of a pressing component 24, and FIG. 17 is a sectional view taken along the line XVII-XVII shown in FIG. 16 (A). The check valve mechanism 51 of the embodiment is equipped with a load adding mechanism 53 using a coiled type compression spring 52. The chemical resistance of the compression spring 52 is improved by performing a nickel plating treatment on stainless steel.

A stepped hole 18b having a larger internal diameter than the outlet part 18c of the discharge opening 18 is formed on the internal circumferential surface of the discharge opening 18 in the discharge opening body 17 of the second sealing case 3. The stepped hole 18b and the stepped part of the jointing section of the outlet part 18c function as a spring seat surface 54 of the compression spring 52. A changable gap is reserved between the internal diameter of the stepped hole 18b and the external diameter of the compression spring 52.

The compression spring 52 is inserted by being clamped between the stepped hole 18b of the second sealing case 3 and the external circumferential surface of the shaft 24a of the pressing component 24. Then, one end of the compression spring 52 is propped against the spring seat surface 54 and the other end of the compression spring 52 is propped against the back side of the pressing section 24b of the pressing component 24. In this way, the compression spring 52 presses the blocking area 5a of the sheet-shaped valve body 5 towards the sheet component 4.

As shown in FIG. 16 (A) and FIG. 16(B), four linear protrusion sections 55a that are formed along the shaft direction of the pressing component 24 on the external circumferential surface of the shaft 24a of the pressing component are located in the circumferential direction at equal intervals. In this way, the linear protrusion sections 55a form a cross-shaped rib 55. The cross-shaped rib 55 determines the center position of the pressing component 24; moreover, a changeable gap is reserved between the linear protrusion sections 55a and the internal circumferential surface of the compression spring 52. Further, the shaft 24a of the pressing component 24 and the internal circumferential surface of the compression spring 52 cannot be directly rotated for the following reason: in the case where the center position of the pressing component 24 is determined according to the shaft diameter of the shaft 24a of the pressing component 24 and there is a changeable gap between the pressing component 24 and the internal circumferential surface of the compression spring 52, an adequate flow path opening cannot be set at the discharge opening 18. In this case, the flow path resistance of the fluid flowing through the discharge opening 18 is increased to prevent the foregoing situation.

(Function•Effect) In the embodiment, a load adding mechanism 53 using a coiled type compression spring 52 is arranged. Under the pressing force of the compression spring 52, the pressing component 24 presses the blocking area 5a of the sheet-shaped valve body 5. The pressing force becomes a spring force by means of which the load adding mechanism 53 adds a load for the blocking area 5a of the sheet-shaped valve body 5 towards the side of the sheet component 4. Thus, the embodiment can achieve the same effect with the check valve mechanism 1 of the first embodiment (refer to FIG. 1 to FIG. 13).

Further, in the embodiment, as a cross-shaped rib 55 is arranged on the external circumferential surface of the shaft 24a of the pressing component 24, a gap can be set between the shaft 24a of the pressing component 24 and the discharge opening 18. Thus, an adequate flow path opening can be set at the discharge opening 18 to reduce the resistance of the flow path.

### Third Embodiment

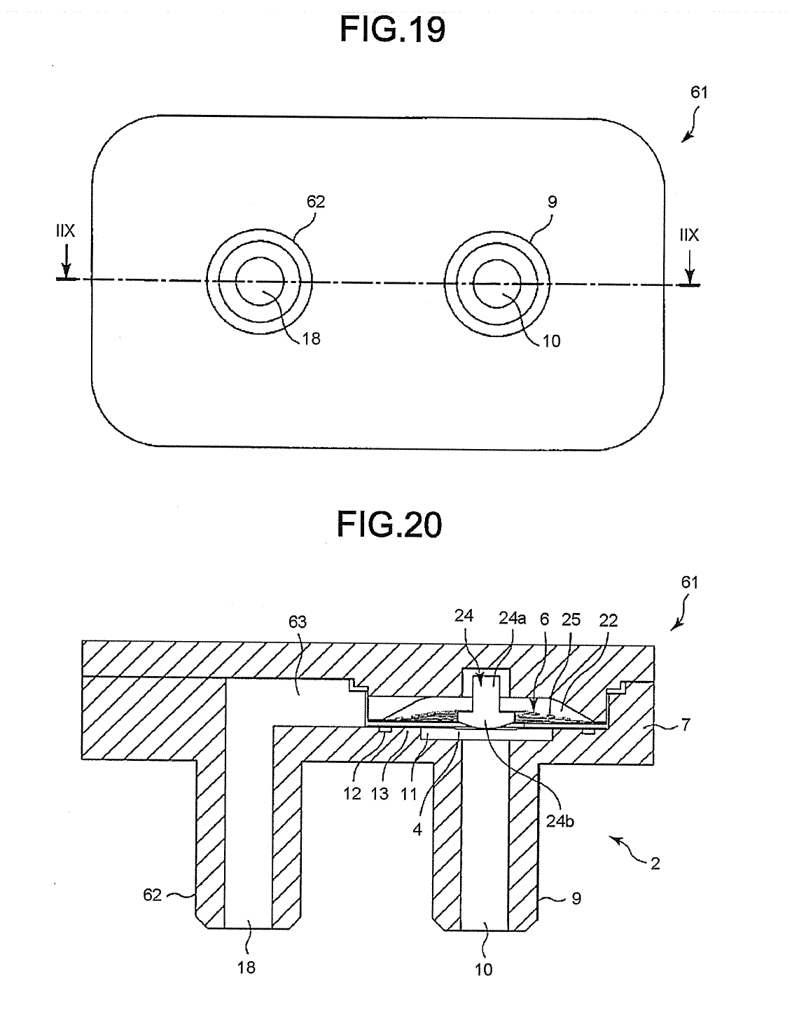

FIG. 19 and FIG. 20 illustrate the third embodiment. The third embodiment is a variation of the first embodiment in which the position of the discharge opening 18 of the check valve mechanism 1 of the first embodiment (refer to FIG. 1-FIG. 13) is changed. Moreover, the same parts shown in FIG. 19-FIG. 20 and FIG. 1-FIG. 13 are denoted by the same reference signs and not described repeatedly.

FIG. 19 is a top view of a check valve mechanism 61 according to the third embodiment; and FIG. 20 is a sectional view taken along the line IIX-IIX shown in FIG. 19. In the check valve mechanism 61 of the third embodiment, a cylindrical suction opening body 9 and a cylindrical discharge opening body 62 are arranged on the first sealing case 2, and a discharge opening 18 is arranged in the axial center of the discharge opening body 62. Further, in the main case body 7 of the first sealing case 2, a discharging flow path 63 communicating with the discharge opening 18 is arranged on a lateral side of the circular recess 22.

(Function•Effect)

In the third embodiment, the cylindrical discharge opening body 62 is arranged on the first sealing case 2, as the discharge opening 18 is arranged on the discharge opening body 62, fluid can flow into the space between the suction opening 10 and the discharge opening 18 merely from one direction.

According to the foregoing embodiments, a check valve mechanism and a pump device using the same are provided which show a high unidirectional performance even in the use of a component made from a material having a small longitudinal elastic coefficient, for example, rubber, function even under a tiny differential pressure and, with an excellent chemical resistance, is improved in the sealing property of the opening of the sheet component and the sheet-shaped valve body and stability.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A check valve mechanism, comprising:
a sealing case having a suction opening for fluid and a discharge opening for fluid and an internal flow path connecting the suction opening with the discharge opening;
a sheet component which is located at the downstream side of the suction in the flow direction of the internal flow path, fixed on the first sealing case by covering the periphery of the suction opening and made from a resin material having an opening at a position corresponding to the suction opening;
a sheet-shaped valve body configured at the downstream side of the sheet component in the flow direction of the internal flow path and made from a resin material having a blocking area for blocking the opening of the sheet component; and
a load adding mechanism configured at the downstream side of the sheet-shaped valve body in the flow direction of the internal flow path to add a load for the blocking area of the sheet-shaped valve body towards the sheet component.

2. The check valve mechanism according to claim 1, wherein
the opening of the sheet component is smaller in area than the suction opening.

3. The check valve mechanism according to claim 1, wherein
the sealing case is smaller in coefficient of linear expansion than the sheet component.

4. The check valve mechanism according to claim 2, wherein
the sealing case is smaller in coefficient of linear expansion than the sheet component.

5. The check valve mechanism according to claim 1, wherein
the opening of the sheet component is formed using a punching die, and the side of the sheet component where the periphery of the opening has no burrs is located at the downstream side of the flow direction of the internal flow path.

6. A pump device, comprising:
a housing;
a suction path through which conveyed fluid flows into the housing;
a discharging flow path through which the conveyed fluid is discharged from the housing;
a pump chamber which is arranged as a partitioning chamber having a suction opening and a discharge opening that are communicated with the inside of the housing and is internally provided with a piezoelectric diaphragm that is vibrated repeatedly by a drive source to suck the conveyed fluid in and eject the conveyed fluid out;
a suction-side check valve which is arranged at the suction opening of the chamber pump and communicated with the suction flow path to prevent the reverse flow of the conveyed fluid; and
a discharge-side check valve which is arranged at the discharge opening of the chamber pump and communicated with the discharging flow path to prevent the reverse flow of the conveyed fluid, wherein
the suction-side check valve and the discharge-side check valve are the check valve mechanism of claim 1.
